(19) United States
(12) Patent Application Publication
(10) Pub. No.: US 2026/0290694 A1
(43) Pub. Date: Sep. 24, 2026

(54) MULTILAYER CERAMIC ELECTRONIC DEVICE

(71) Applicant: TDK Corporation, Tokyo (JP)

(72) Inventors: Ryota NAMIKI, Tokyo (JP); Toshihiro IGUCHI, Tokyo (JP); Atsushi WATANABE, Tokyo (JP)

(73) Assignee: TDK Corporation, Tokyo (JP)

(21) Appl. No.: 19/569,440

(22) Filed: Mar. 17, 2026

(30) Foreign Application Priority Data
Mar. 19, 2025 (JP) 2025-045513

(51) Int. Cl. H01G 4/12; H01G 4/005; H01G 4/232; H01G 4/30

(52) U.S. Cl. CPC H01G 4/1245; H01G 4/005; H01G 4/30; H01G 4/232

(57) ABSTRACT

A multilayer ceramic electronic component includes a first internal electrode layer and a second internal electrode layer. At least one of the first internal electrode layer and the second internal electrode layer includes a floating electrode. An insulating layer includes a main component containing a perovskite-type compound and also includes a subcomponent. The perovskite-type compound contains at least Ca as an A-site element and at least Zr as a B-site element. The subcomponent contains at least one selected from the group consisting of V, Nb, Ta, and W as a first subcomponent element. A total content of the first subcomponent element is 0.005 parts by mol or more and 0.80 parts by mol or less per 100 parts by mol of B-site elements.

### TECHNICAL FIELD

The present disclosure relates to a multilayer ceramic electronic device, including a multilayer ceramic capacitor.

### BACKGROUND

Dielectric compositions that are obtained by sintering a mixture of a base material and additives including Mn, Al, and Si are known in the art. As disclosed in, for example, Patent Document 1, the base material is based on (Ca₁₋ₓSrₓ)ₘ(Zr_{1-y}Ti_{y})O₃, in which the following conditions are satisfied: 0≤x≤1, 0.09≤y≤0.35, and 0.7≤m≤1.05. Dielectric compositions with such a composition have been used in insulating layers of multilayer ceramic electronic devices, such as multilayer ceramic capacitors. However, these devices are still required to exhibit high withstand voltage to accommodate recent increases in operating voltage.

In view of this, attention has been directed to the structure of internal electrodes of electronic components. Specifically, an internal electrode structure has been considered, in which an internal electrode is configured as a floating electrode that is not connected to either of a pair of external electrodes. In electronic devices having such an internal electrode structure, a voltage between internal electrodes can be reduced, and thus withstand voltage is improved, compared with electronic devices having structures without floating electrodes.

### PATENT DOCUMENT

Patent Document 1: JP Patent Application Laid Open No. 2007-091588

### SUMMARY

On the other hand, in electronic devices having such an internal electrode structure with floating electrodes, between a pair of external electrodes, there is a region having a relatively small number of laminated internal electrodes (which may be referred to as an M-gap region) located between regions having a relatively large number of laminated internal electrodes. The present inventors have newly found that deflection or cracking tends to originate from the M-gap region at a high occurrence rate.

An object of the present disclosure is to provide a multilayer ceramic electronic device having both improved withstand voltage characteristics and enhanced resistance to deflection-induced cracking.

To achieve the above object, a multilayer ceramic electronic device according to the present disclosure includes:
an element body having a laminated structure including an insulating layer interposed between a first internal electrode layer and a second internal electrode layer; and two external electrodes formed on outer surfaces of the element body,
wherein at least one of the first internal electrode layer and the second internal electrode layer includes a floating electrode that is not connected to either of the two external electrodes,
the insulating layer includes a main component including a perovskite-type compound and also includes a subcomponent,
the perovskite-type compound includes at least Ca as an A-site element and at least Zr as a B-site element,
the subcomponent includes at least one selected from the group consisting of V, Nb, Ta, and W as a first subcomponent element, and
a total content of the first subcomponent element is 0.005 parts by mol or more and 0.80 parts by mol or less per 100 parts by mol of B-site elements.

The multilayer ceramic electronic device exhibits both improved withstand voltage characteristics and enhanced resistance to deflection-induced cracking.

Preferably, the total content of the first subcomponent element is 0.01 parts by mol or more and 0.75 parts by mol or less per 100 parts by mol of B-site elements. Within this range, both withstand voltage characteristics and resistance to deflection-induced cracking are further improved.

The insulating layer may include main phase grains composed mainly of the main component and may also include grain boundaries present between the main phase grains.

Preferably, an average grain size of the main phase grains is 0.08 to 3.51 μm. Within this range, both withstand voltage characteristics and resistance to deflection-induced cracking are further improved.

Preferably, the first subcomponent element is present in a larger amount in the grain boundaries than in the main phase grains. Under these conditions, both withstand voltage characteristics and resistance to deflection-induced cracking are further improved.

Preferably, the perovskite-type compound further contains at least Sr as the A-site element and contains at least Ti as the B-site element. Under these conditions, both withstand voltage characteristics and resistance to deflection-induced cracking are further improved.

Preferably, the perovskite-type compound is represented by the following formula: (Ca₁₋ₓSrₓBa_{α})ₘ(Zr_{1-y-z}Ti_{y}Hf_{z})O₃,
in which the following conditions are satisfied: 0.9≤m≤1.1, 0≤x≤1, 0.80≤1−y−z≤1.0, and α<1. Under these conditions, both withstand voltage characteristics and resistance to deflection-induced cracking are further improved.

### BRIEF DESCRIPTION OF THE DRAWINGS

FIG. 1A is a schematic cross-sectional view of a multilayer ceramic capacitor according to an embodiment of the present disclosure.

FIG. 1B is a schematic cross-sectional view of a multilayer ceramic capacitor according to another embodiment of the present disclosure.

FIG. 2 is a HAADF image of the insulating layer shown in FIG. 1A.

FIG. 3 is an enlarged view of a portion of the HAADF image shown in FIG. 2.

FIG. 4 is a schematic view showing results of line analysis of W at the main phase grain and the grain boundary shown in FIG. 3.

FIG. 5 is a schematic view showing results of line analysis of WO₃+MnO at the main phase grain and the grain boundary shown in FIG. 3.

FIG. 6 is a schematic view illustrating a deflection-induced cracking test.

### DETAILED DESCRIPTION OF THE PREFERRED EMBODIMENTS

Hereinafter, embodiments of the present disclosure will be described.

### First Embodiment

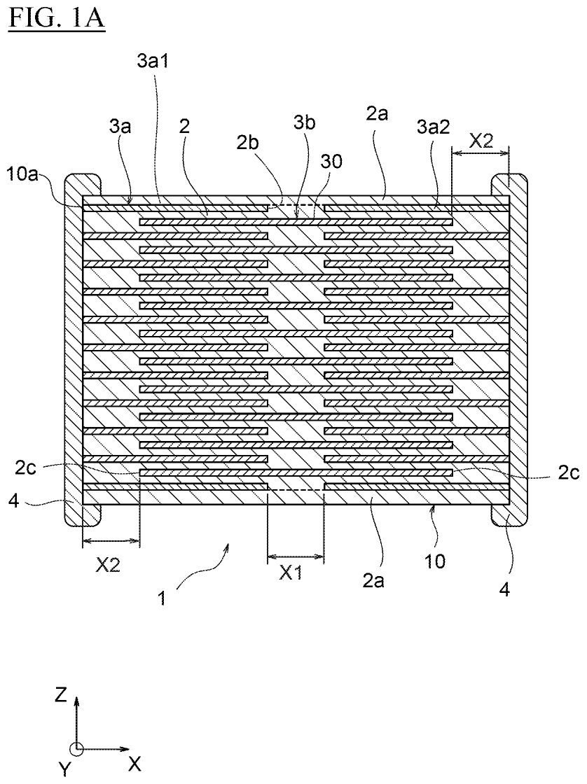

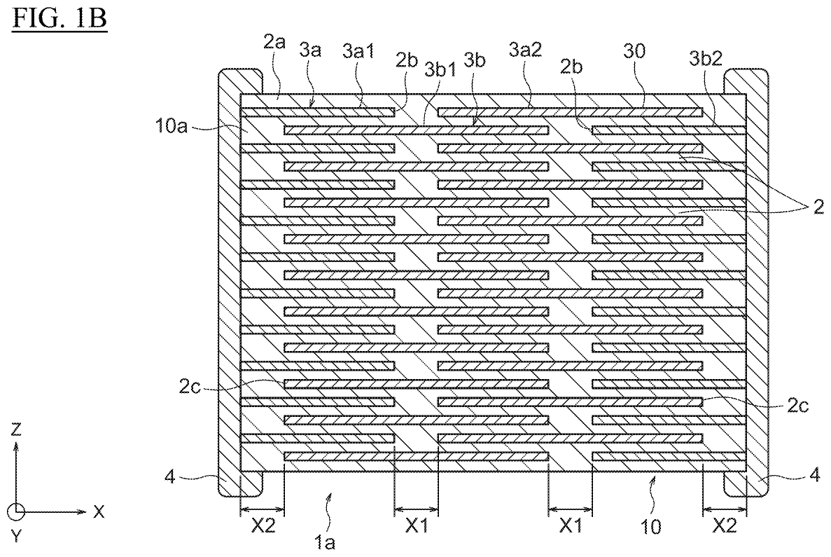

FIG. 1A shows a multilayer ceramic capacitor 1 as an example of a multilayer ceramic electronic device according to the present embodiment. The multilayer ceramic capacitor 1 includes an element body 10 having a laminated structure, in which an internal dielectric layer 2 used as an insulating layer is interposed between a first internal electrode layer 3a and a second internal electrode layer 3b. In the element body 10, the first internal electrode layers 3a and the second internal electrode layers 3b are alternately laminated along the Z-axis with the internal dielectric layers 2 each disposed therebetween.

The shape of the element body 10 is not particularly limited, but is typically a rectangular parallelepiped. However, the element body 10 may have an elliptical cylindrical shape, a circular cylindrical shape, a prismatic shape, or the like. In addition, the dimensions of the element body 10 are not particularly limited, and may be appropriately selected depending on the intended application. For example, the length in the X-axis direction may be 0.4 to 5.7 mm, the width in the Y-axis direction may be 0.2 to 5.0 mm, and the height TO in the Z-axis direction may be 0.05 to 3.0 mm. In the present embodiments, the X-axis, the Y-axis, and the Z-axis are orthogonal to each other.

An external dielectric layer 2a used as an insulating layer is laminated at each end surface along the laminated direction (Z-axis) of the element body 10, thereby protecting the interior of the element body 10. An external electrode 4 is provided to each end surface 10a along the X-axis of the element body 10. Each of the external electrodes 4 is connected to a corresponding end of the first internal electrode layer 3a. The second internal electrode layer 3b is not connected to either of the external electrodes 4 and serves as a floating electrode inside the element body 10.

The first internal electrode layer 3a has an M-gap 2b with a predetermined width X1 at an intermediate portion thereof along the X-axis. In the M-gap 2b, an insulating layer portion is interposed along the Y-axis direction and has the same composition as or a different composition from that of the internal dielectric layer 2 or the external dielectric layer 2a. The insulating layer portion divides the first internal electrode layer 3a into two divided electrode layers 3a1 and 3a2 that are mutually insulated.

The second internal electrode layer 3b has a W-gap 2c with a predetermined width X2 between one end thereof and one of the external electrodes 4 along the X-axis. The second internal electrode layer 3b also has a W-gap 2c with a predetermined width X2 between the other end thereof and the other external electrode 4 along the X-axis. In the W-gap 2c, an insulating layer portion is interposed along the Y-axis direction and has the same composition as or a different composition from that of the internal dielectric layer 2 or the external dielectric layer 2a. The insulating layer portion insulates the second internal electrode layer 3b from both external electrodes 4 so that the second internal electrode layer 3b functions as a floating electrode 30 in the element body 10.

In the present embodiment, the internal electrode layers 3a and 3b having two different patterns as described above are alternately laminated with the internal dielectric layer 2 interposed therebetween. The second internal electrode layer 3b has a pattern that covers the insulating pattern portion of the first internal electrode layer 3a insulated at an intermediate portion in the X-axis direction, and that is not connected to either of the external electrodes 4 at respective ends in the X-axis direction.

In the capacitor 1, a portion of the internal dielectric layer 2 in which the first and second internal electrode layers 3a and 3b overlap when viewed in the Z-axis direction contributes to the capacitance of the capacitor 1. In the capacitor 1, portions of the internal dielectric layer 2 in which the first and second internal electrode layers 3a and 3b overlap when viewed in the Z-axis direction are formed at two locations along the X-axis direction. Therefore, the electrode structure of the capacitor 1 is referred to as a two-series structure.

The portion of the M-gap 2b having the width X1 and the portion of the W-gap 2c having the width X2 do not contribute to the capacitance of the capacitor 1. Although not illustrated, L-gaps each having a predetermined width Y1 are formed between ends of the first and second internal electrode layers 3a and 3b along the Y-axis and corresponding ends of the element body 10 along the Y-axis. These L-gaps also do not contribute to the capacitance of the capacitor 1.

The width X1 of the M-gap 2b is not particularly limited as long as it is sufficient to electrically insulate the two divided electrode layers 3a1 and 3a2 from each other. For example, the width X1 is preferably 50 μm or more. If the width X1 is too large, a portion that does not contribute to the capacitance of the capacitor 1 is excessively large. Therefore, the upper limit of the width X1 is preferably less than 800 μm. The widths X2 of the two W-gaps 2c may be the same as or different from each other, and are preferably within a range similar to that of the width X1, that is, 50 μm or more and less than 800 μm. Similarly, the predetermined width Y1 of the L-gap is preferably 50 μm or more and less than 800 μm.

The internal dielectric layers 2 include a dielectric ceramic composition according to the present embodiment, as described later. The thickness per layer (interlayer thickness) of the internal dielectric layers 2 is not particularly limited, and may be set as appropriate according to desired characteristics and applications. The interlayer thickness is preferably 100 μm or less, more preferably 60 μm or less, and still more preferably 30 μm or less. The number of laminated internal dielectric layers 2 is not particularly limited. For example, in the present embodiment, the number is preferably 20 or more.

The internal electrode layers 3a and 3b contain a metal-based conductive material. The metal is not particularly limited, and may include known conductive materials such as Pd, Pd-based alloys, Pt, Pt-based alloys, Ni, Ni-based alloys, Cu, and Cu-based alloys. The metal may contain various trace components such as P, S, and Cl, each in an amount of about 0.1 mass % or less. Each of the internal electrode layers 3a and 3b may be formed using a commercially available electrode paste. The thickness of each of the internal electrode layers 3a and 3b may be appropriately determined depending on the intended application.

The external electrodes 4 include a conductive material, which is not particularly limited. Examples of the conductive material include known conductive materials such as Ni, Cu, Sn, Ag, Pd, Pt, Au, alloys thereof, and conductive resins. The thickness of the external electrodes 4 may be appropriately determined depending on the intended application.

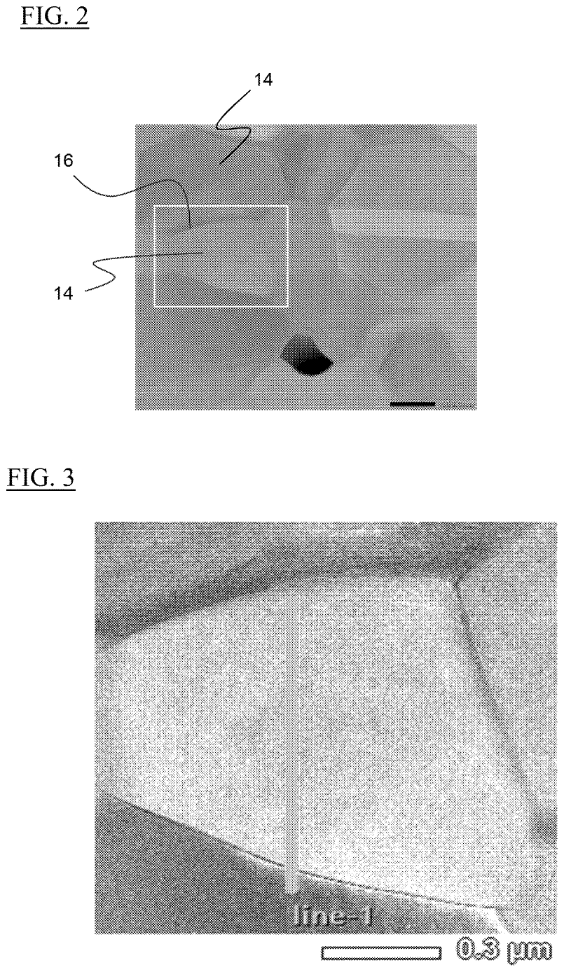

The method for observing the structure of the dielectric ceramic composition is not particularly limited. For example, a cross section of the dielectric ceramic composition may be observed using a backscattered electron image or a HAADF image. The backscattered electron image may be obtained using, for example, a scanning electron microscope (SEM). The HAADF image may be obtained using, for example, a scanning transmission electron microscope (STEM). A HAADF image of a cross section of a dielectric ceramic composition is shown in FIG. 2. Hereinafter, a HAADF image that is obtained using STEM may be simply referred to as a STEM image.

As shown in FIG. 2, the dielectric ceramic composition according to the present embodiment includes main phase grains 14 and grain boundaries 16 present between the main phase grains 14. In backscattered electron images and HAADF images, the main phase grains 14 tend to appear as bright regions compared with grain boundaries 16. This is because the main phase grains 14 tend to be denser than the grain boundaries 16. Thus, the grain boundaries 16, which typically have a lower density than the main phase grains 14, tend to appear as dark regions.

The field of view to be imaged is not particularly limited. For example, the field of view may have dimensions of about 1 to 10 μm on each side and an area of about 1 to 100 μm². The dimensions of the field of view may be appropriately selected depending on the intended purposes.

The main phase grain 14 contains a perovskite-type compound as a main component. The perovskite-type compound has a perovskite-type crystal structure represented by the general formula ABO₃, in which A represents at least one A-site element and B represents at least one B-site element.

The perovskite-type compound contains, as A-site elements, at least Ca, preferably Ca and Sr, and contains, as B-site elements, at least Zr, preferably Zr and Ti. In addition, Ba may be further included as an A-site element, and Hf may be further included as a B-site element.

When Ca is not included as an A-site element, withstand voltage characteristics are reduced, and resistance to deflection-induced cracking tends to decrease. When Zr is not included as a B-site element, withstand voltage characteristics are reduced, and resistance to deflection-induced cracking tends to decrease.

The content of Ca per 100 parts by mol of A-site elements may be 10 parts by mol or more and 100 parts by mol or less, 30 parts by mol or more and 100 parts by mol or less, 30 parts by mol or more and 90 parts by mol or less, or 50 parts by mol or more and 80 parts by mol or less. The content of Sr per 100 parts by mol of A-site elements may be 0 parts by mol or more and 50 parts by mol or less, 10 parts by mol or more and 50 parts by mol or less, or 20 parts by mol or more and 45 parts by mol or less. The content of Ba per 100 parts by mol of A-site elements may be 0 parts by mol or more and 25 parts by mol or less, 0 parts by mol or more and 20 parts by mol or less, or 0 parts by mol or more and 5.0 parts by mol or less.

The content of Zr per 100 parts by mol of B-site elements may be 90 parts by mol or more and 100 parts by mol or less, 90 parts by mol or more and 99 parts by mol or less, or 94 parts by mol or more and 98 parts by mol or less. The content of Ti per 100 parts by mol of B-site elements may be 0 parts by mol or more and less than 7.0 parts by mol, 0.5 parts by mol or more and less than 7.0 parts by mol, or 2.0 parts by mol or more and 6.0 parts by mol or less. The content of Hf per 100 parts by mol of B-site elements may be 0 parts by mol or more and 2.0 parts by mol or less.

The perovskite-type compound of the present embodiment may also be represented by the following formula: (Ca₁₋ₓSrₓBa_{α})ₘ(Zr_{1-y-z}Ti_{y}Hf_{z})O₃, in which the following conditions are satisfied: 0.9≤m≤1.1, 0≤x≤1, 0.80≤1−y−z≤1.0, and α<1.

The dielectric ceramic composition according to the present embodiment contains, in addition to the perovskite-type compound described above, at least one selected from the group consisting of V, Nb, Ta, and W as a first subcomponent element Z1. Including such subcomponent elements improves both withstand voltage characteristics and crack resistance characteristics. These subcomponent elements are incorporated into the main phase grains and, in particular, into the grain boundaries, thereby changing the grain boundary structure and enhancing the mechanical strength of the dielectric layer.

In the dielectric ceramic composition according to the present embodiment, the total content of Z1 with respect to the total content of the B-site elements, namely, Zr, Ti, and Hf, is 0.005 parts by mol or more and 0.80 parts by mol or less, and is preferably 0.01 parts by mol or more and 0.75 parts by mol or less.

The dielectric ceramic composition according to the present embodiment may further contain, in addition to the perovskite-type compound and Z1 described above, at least one selected from the group consisting of Mn, Cr, Si, and Al, or at least one selected from the group consisting of Mn, Si, and Al, as a second subcomponent element Z2. Alternatively, the dielectric ceramic composition according to the present embodiment may contain, as a second subcomponent element Z2, Si, Al, and at least one selected from the group consisting of Mn and Cr. Including such subcomponent elements can improve sinterability and withstand voltage characteristics as well as crack resistance characteristics.

In the dielectric ceramic composition according to the present embodiment, the total content of Z2 with respect to the total content of the B-site elements, namely, Zr, Ti, and Hf, is not particularly limited, and may be 1.8 parts by mol or more and 7.0 parts by mol or less. At least a part of Z2 is also expected to function as a sintering aid.

In the dielectric ceramic composition according to the present embodiment, the total content of Mn and Cr may exceed the content of Si, and at the grain boundary 16, the content of Si may exceed the total content of Mn and Cr. Specifically, in the dielectric ceramic composition, a value that is obtained by subtracting the content of Si per 100 parts by mol of B-site elements from the total content of Mn and Cr per 100 parts by mol of B-site elements may be 0.1 parts by mol or more. In addition, at the grain boundaries 16, a value obtained by subtracting the total content of Mn and Cr per 100 parts by mol of B-site elements from the content of Si per 100 parts by mol of B-site elements may be 0.1 parts by mol or more.

The total content of Ti, Mn, Cr, and Z1 per 100 parts by mol of B-site elements may be 8.0 parts by mol or less. Moreover, at least one selected from the group consisting of Mg, Li, B, P, and V may be contained as a third subcomponent element Z3. The total content of the third subcomponent element Z3 with respect to the total content of Zr, Ti, and Hf may be zero; however, when the third subcomponent element Z3 is contained, the total content of the second and third subcomponent elements Z2 and Z3 is preferably 7.0 parts by mol or less.

An average grain size of the main phase grain 14 is not particularly limited, but is preferably 0.08 to 3.51 μm, more preferably 0.11 to 2.95 μm. Within this range, both withstand voltage characteristics and resistance to deflection-induced cracking are improved.

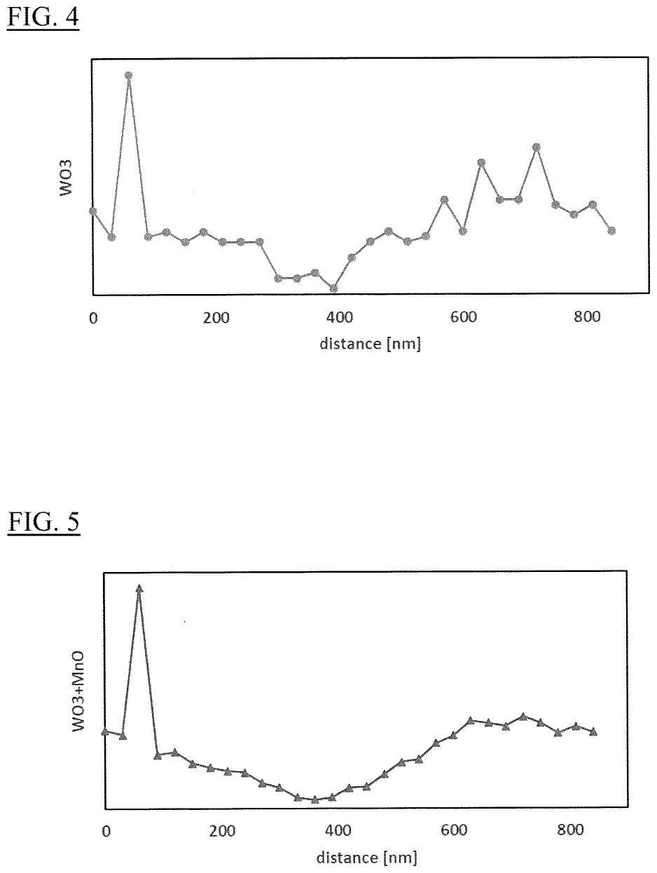

In the dielectric ceramic composition, 99 wt % or more of the A-site elements, the B-site elements, Z1, Z2, and Z3 are contained as simple oxides or complex oxides. FIGS. 4 and 5, which will be described later, show changes in contents of simple oxides of these elements. More precisely, changes in content of each element converted into a simple oxide are shown. Each element is contained as a simple oxide, a complex oxide, or the like, in the dielectric ceramic composition.

At least a part of the main phase grains 14 contained in the dielectric ceramic composition according to the present embodiment may be specific main phase grains. The specific main phase grain refers to a main phase grain 14 having a first fine region and a second fine region. The first fine region is included in a circumferential portion, whereas the second fine region is included in a central portion. The content of Z1 per 100 parts by mol of B-site elements is smaller in the second fine region than in the first fine region.

When the total content of all elements included in the first fine region is defined as 100 parts by mol in terms of oxide conversion, the content of Z1 included in the first fine region may be 0.08 parts by mol or more in terms of oxide conversion. When the total content of all elements included in the second fine region is defined as 100 parts by mol in terms of oxide conversion, the content of Z1 included in the second fine region may be less than 0.08 parts by mol in terms of oxide conversion.

In any cross section of the dielectric ceramic composition, the circumferential portion of the main phase grain 14 refers to a region within a distance of one-fourth or less of an equivalent circular radius from the grain boundary 16 toward the main phase grain 14. The first fine region may have a thickness of one-fourth or more of an equivalent circular radius from the grain boundary 16 toward the main phase grain 14.

The center of the main phase grain 14 refers to a centroid of the main phase grain 14 in any cross section. The central portion of the main phase grain 14 refers to a region within a distance of one-half or less of an equivalent circular radius from the centroid of the main phase grain 14. The equivalent circular radius is defined as a radius of a circle having an area equal to that of the main phase grain 14. The equivalent circular radius is one-half of an equivalent circular diameter.

The ratio of the number of the specific main phase grains to the number of the main phase grains 14 contained in the dielectric ceramic composition may be 5% or more and 95% or less, and may be 10% or more and 95% or less. To calculate this ratio, first, observation is performed on two or more fields of view each having an observation range of 6.0 μm² or more in any cross section of the dielectric ceramic composition. Then, the number of main phase grains 14 which are entirely contained within the observation range is calculated. Moreover, among the main phase grains 14 entirely contained within the observation range, the number of specific main phase grains is calculated. Finally, the above-described ratio is determined.

The area ratio of the first fine region may be 5% or more and 95% or less, and may be 20% or more and 95% or less, in any cross section of the dielectric ceramic composition. To calculate the area ratio of the first fine region, first, observation is performed on two or more fields of view each having an observation range of 6.0 μm² or more in any cross section of the dielectric ceramic composition. Then, the total area of the first fine regions in the main phase grains 14 within the observation range is divided by the area of the observation range.

Changes in content of each element in the main phase grain 14 and the grain boundary 16 will be described with reference to specific examples.

FIG. 3 is a STEM image of an enlarged portion indicated by a square in FIG. 2. Line analysis was performed using STEM-EDS from a lower end to an upper end along a line indicated as line-1 in FIG. 3, and results thereof are shown in the graphs of FIGS. 4 and 5. The dielectric ceramic composition for which various measurement results are shown in FIGS. 2 to 5 contains W as Z1; however, similar tendencies can be obtained even when another element is used as Z1 instead of W. This dielectric ceramic composition contains Mn as Z2 and does not contain Cr as Z2; however, similar tendencies can still be obtained even when Cr is used as Z2 instead of Mn.

As shown in FIGS. 4 and 5, in the main phase grain 14, both the content of W (the content of Z1) and the total content of W and Mn tend to increase as the grain boundary 16 is approached. Both the content of W and the total content of W and Mn are significantly higher in the grain boundary 16 than in the main phase grain 14 (in particular, the circumferential portion of the specific main phase grain).

In the first fine region of the specific main phase grain, the ratio, in terms of atomic ratio, of the total content of Mn, Cr, and Z1 to Z3 to the total content of Z1 to Z3 may be 0.2 or more. In the second fine region of the specific main phase grain, the ratio, in terms of atomic ratio, of the total content of Mn, Cr, and Z1 to Z3 to the total content of Z1 to Z3 may be less than 0.2.

The dielectric ceramic composition may include a segregated region in addition to the main phase grain 14 and the grain boundary 16. The segregated region may contain Mn as a constituent element.

An example of a method for manufacturing the multilayer ceramic capacitor 1 shown in FIG. 1A is described below.

First, a manufacturing process of the element body 10 is described. In the manufacturing process of the element body 10, a dielectric paste that becomes the dielectric layers 2 and 2a after firing and an internal electrode paste that becomes the internal electrode layers 3a and 3b after firing are prepared.

The method for manufacturing the dielectric paste is not particularly limited. For example, the dielectric paste may be manufactured by the following method. First, a raw material powder mainly for forming main phase grains 14 of the dielectric ceramic composition (which may hereinafter be referred to as a main component raw material powder) is prepared. A commercially available perovskite-type compound powder may be used as the raw material powder.

Alternatively, oxide powders of A-site elements and B-site elements of a perovskite-type compound may be used. The oxide powders may be dispersed in a solvent (for example, purified water), dried, and then heat-treated to prepare a raw material powder. The holding temperature in the heat treatment for preparing the raw material powder is not particularly limited. For example, the holding temperature may be 900° C. or higher and 1300° C. or lower. The holding time is not particularly limited. For example, the holding time may be 0.5 hours or longer and 5 hours or shorter.

In addition, oxide powders of additive elements (subcomponent elements) may be dispersed simultaneously in the solvent together with the oxide powders of A-site elements and B-site elements of the perovskite-type compound.

Instead of the oxide powders of respective elements, compound powders that become oxides of the respective elements upon sintering may be used. For example, carbonate powders of the respective elements may be used. Alternatively, complex compound powders of the respective elements may be used.

A part of powders of additive elements may be added as a sintering aid containing at least one selected from the group consisting of Al₂O₃, MnCO₃, and SiO₂. The sintering aid may be prepared by mixing powders of these three compounds and calcining the mixture. The sintering aid may be added in an appropriately selected amount; for example, it may be 1 part by weight or more and 5 parts by weight or less per 100 parts by weight of the perovskite-type compound powder.

In the sintering aid, the content of MnCO₃ may be 55 wt % or more and 75 wt % or less, the content of Al₂O₃ may be 2 wt % or more and 15 wt % or less, and the content of SiO₂ may be 15 wt % or more and 40 wt % or less.

After the main component raw material powder and the sintering aid are mixed, the mixture and oxide powders of additive elements (compound powders that become oxides of respective elements upon sintering may be used) may be dispersed together in a solvent (for example, purified water), dried, and heat-treated. Thus, a dielectric powder may be prepared. The holding temperature in the heat treatment is not particularly limited. For example, the holding temperature may be 300° C. or higher and 700° C. or lower. The holding time is not particularly limited. For example, the holding time may be 0.5 hours or longer and 5 hours or shorter.

For the oxide powders of the additive elements, at least a part thereof may be calcined to obtain a calcined material. The above-described mixture, the calcined material, and the rest of the oxide powders of the additive elements may be dispersed together in a solvent.

Alternatively, the main component raw material powder and oxide powders of additive elements other than a sintering aid may be mixed and calcined to obtain a calcined material. The calcined material and the sintering aid may be dispersed together in a solvent.

Thereafter, the obtained dielectric powder, a binder, and a solvent (organic solvent or water) are kneaded together to prepare a dielectric paste. The types of the binder and the solvent are not particularly limited. An organic vehicle obtained by mixing a binder and an organic solvent may be used instead of the binder and the solvent. If necessary, the dielectric paste may contain additives, such as plasticizers and dispersants.

The internal electrode paste is obtained by kneading together a raw material for the above-described conductive material, a binder, and a solvent (organic solvent or water). The types of the binder and the solvent are not particularly limited. If necessary, the internal electrode paste may contain additives such as sintering inhibitors and plasticizers.

The prepared pastes are used to form green sheets and internal electrode patterns, which are then laminated together to obtain a green chip.

The resultant green chip may be subject to a binder removal treatment as necessary. The binder removal treatment may be performed under known conditions. For example, the holding temperature may be 180° C. or higher and 400° C. or lower, and the holding time may be 0.5 hours or longer and 24 hours or shorter. In addition, the atmosphere during the binder removal treatment is not particularly limited. Under a reducing atmosphere, the holding temperature may be 1100° C. or lower.

After the binder removal treatment, the green chip is fired to obtain the element body 10. In the present embodiment, the firing atmosphere may be a reducing atmosphere with an oxygen partial pressure of 2.0×10⁻¹³ atm or higher and 1.0×10⁻⁷ atm or lower. Other firing conditions may be known conditions. For example, the holding temperature may be 1200° C. or higher and 1400° C. or lower, and the holding time may be 0.5 hours or longer and 8 hours or shorter.

After firing, an annealing treatment may be performed as necessary. The conditions for the annealing treatment are not particularly limited. For example, the holding temperature may be 500° C. or higher and 1150° C. or lower, and the holding time may be 0.5 hours or longer and 20 hours or shorter. The oxygen partial pressure in the annealing atmosphere may be 1.0×10⁻⁹ atm or higher and 3.0×10⁻⁵ atm or lower.

In the element body 10 obtained as described above, the dielectric layers 2 and 2a are constituted by the dielectric ceramic composition described above. The end surfaces of the element body 10 are polished as necessary. Then, an external electrode paste is applied to the end surfaces and is baked to form the external electrode 4. Thereafter, if necessary, a coating layer is formed on the surfaces of the external electrodes 4 by plating or the like. The method for preparing the external electrode paste is not particularly limited and may be the same as or similar to the method for preparing the internal electrode paste.

Thus, the multilayer ceramic capacitor 1 according to the present embodiment is manufactured.

The multilayer ceramic capacitor 1 of the present embodiment exhibits both improved withstand voltage characteristics and enhanced resistance to deflection-induced cracking.

### Second Embodiment

FIG. 1B shows a multilayer ceramic capacitor 1a as an example of the multilayer ceramic electronic device according to the present embodiment. The multilayer ceramic capacitor 1a has substantially the same configuration as the capacitor 1 shown in FIG. 1A, except for the pattern structure of the internal electrode layers 3a and 3b. In the following description, common portions will be omitted as appropriate, and differences will be mainly described.

In the present embodiment, the first internal electrode layer 3a has an M-gap 2b with a predetermined width X1 at an intermediate portion thereof along the X-axis. In the M-gap 2b, an insulating layer portion is interposed along the Y-axis direction and has the same composition as or a different composition from that of the internal dielectric layer 2 or the external dielectric layer 2a. The insulating layer portion divides the first internal electrode layer 3a into two divided electrode layers 3a1 and 3a2 that are mutually insulated.

In the present embodiment, one end along the X-axis of the divided electrode layer 3a1 is connected to one external electrode 4. One end along the X-axis of the divided electrode layer 3a2 is insulated from the divided electrode layer 3a1 by the M-gap 2b. In addition, the other end along the X-axis of the divided electrode layer 3a2 is insulated from the external electrode 4 via a W-gap 2c with a predetermined width X2. Accordingly, the divided electrode layer 3a2 serves as a floating electrode 30 that is not connected to either of the external electrodes 4.

In the present embodiment, the second internal electrode layer 3b has an M-gap 2b with a predetermined width X1 at an intermediate portion thereof along the X-axis, the intermediate portion being different in position from that of the first internal electrode layer 3a. In the M-gap 2b, an insulating layer portion is interposed along the Y-axis direction and has the same composition as or a different composition from that of the internal dielectric layer 2 or the external dielectric layer 2a. The insulating layer portion divides the second internal electrode layer 3b into two divided electrode layers 3b1 and 3b2 that are mutually insulated.

In the present embodiment, one end along the X-axis of the divided electrode layer 3b2 is connected to one external electrode 4. One end along the X-axis of the divided electrode layer 3b1 is insulated from the divided electrode layer 3b2 by the M-gap 2b. In addition, the other end along the X-axis of the divided electrode layer 3b1 is insulated from the external electrode 4 via a W-gap 2c with a predetermined width X2. Accordingly, the divided electrode layer 3b1 serves as a floating electrode 30 that is not connected to either of the external electrodes 4.

In the capacitor 1a, a portion of the internal dielectric layer 2 in which the first and second internal electrode layers 3a and 3b overlap when viewed from the Z-axis direction contributes to the capacitance of the capacitor 1a. In the capacitor 1a, portions of the internal dielectric layer 2 in which the first and second internal electrode layers 3a and 3b overlap when viewed in the Z-axis direction are formed at three locations along the X-axis direction. Therefore, such an electrode structure of the capacitor is referred to as a three-series structure.

Similarly, the numbers of divisions along the X-axis of the first internal electrode layer 3a and the second internal electrode layer 3b may be increased, with the division portions of the second internal electrode layer 3b shifted from those of the first internal electrode layer 3a. As a result, the number of overlapping portions between the internal electrode layers 3a and 3b can be increased to 4, 5, or n. The capacitor electrode structure in which the number of overlapping portions between the internal electrode layers 3a and 3b is four, five, or n is referred to as a four-series structure, a five-series structure, or an n-series structure, respectively.

A multilayer ceramic electronic device having a three-series structure or a four-, five-, or n-series structure can also exhibit the same or similar effects as those of the multilayer ceramic electronic device 1 of the first embodiment.

The present disclosure is not limited to the above-described embodiments and can be variously changed and modified within the scope of the present disclosure.

For example, although the above-described embodiments have been described with reference to a multilayer ceramic capacitor as one example of a multilayer ceramic electronic device, the present disclosure may also be applied to composite ceramic electronic devices including a capacitor and a coil, or to multilayer ceramic electronic devices other than capacitors.

### EXAMPLES

Hereinafter, the present disclosure will be described in further detail with reference to the following examples. However, the present disclosure is not limited to these examples.

### Experimental Example 1: Sample No. 1

In Experimental Example 1, the capacitor sample of Sample No. 1 having the structure of the multilayer ceramic capacitor 1 shown in FIG. 1A was manufactured according to the following procedure.

First, a dielectric paste for forming the internal dielectric layer 2 and the external dielectric layer 2a was prepared.

A raw material powder (which may hereinafter be referred to as a main component raw material powder) of a perovskite-type compound contained as a main component of main phase grains was obtained. Specifically, raw material powders of Ca oxide, Sr oxide, Zr oxide, Ti oxide, and Hf oxide were prepared and were weighed so as to obtain the perovskite-type compound shown in Table 1. Then, the powders were dispersed in purified water, dried, and then heat-treated (holding temperature: 1150 to 1250° C., holding time: 0.5 to 5 hours) to obtain a main component raw material powder. The raw material powder of each oxide may include not only an oxide powder but also a powder of compound that becomes an oxide upon heat treatment.

At the same time as, or before or after, preparation of the main component raw material powder, a raw material powder of W oxide was prepared and weighed as a raw material powder containing a first subcomponent element Z1. Specifically, for Sample No. 1, the raw material powder was weighed such that the content of W in parts by mole was the value shown in Table 1 with respect to 100 parts by mole of the total number of moles of the B-site elements (the total number of moles of Zr, Ti, and Hf) constituting the main component of the perovskite structure.

At the same time as, or before or after, preparation of the raw material powder, a raw material powder containing a second subcomponent element Z2 was prepared. Specifically, powders of MnCO₃ in an amount of 64.8 wt %, Al₂O₃ in an amount of 7.5 wt %, and SiO₂ in an amount of 27.7 wt % were mixed and calcined. The raw material powder containing the second subcomponent element Z2 (Mn, Al, Si, and Cr) was weighed such that the total content of the second subcomponent element Z2 was 1.8 parts by mol or more and 7.0 parts by mol or less per 100 parts by mol of B-site elements (the total number of moles of Zr, Ti, and Hf).

The main component raw material powder, the raw material powder containing the first subcomponent element Z1, and the raw material powder containing the second subcomponent element Z2 were dispersed in purified water, dried, and then heat-treated to obtain a dielectric raw material powder. In the heat treatment, the holding temperature was set to 400° C., and the holding time was set to 2.0 hours.

The dielectric raw material powder and an organic vehicle were kneaded together to prepare a dielectric paste. Specifically, 10 parts by mass of polyvinyl butyral resin, 5 parts by mass of dioctyl phthalate (DOP) as a plasticizer, and 100 parts by mass of alcohol as a solvent were added to 100 parts by mass of the dielectric raw material powder. They were mixed into a paste using a ball mill to obtain a dielectric paste.

At the same time as, or before or after, preparation of the dielectric paste, an internal electrode paste was also prepared. First, Ni powder, terpineol, ethyl cellulose, and benzotriazole were prepared in a mass ratio of 44.6:52.0:3.0:0.4. They were then kneaded into a paste using a triple-roll mill to obtain an internal electrode paste.

Next, the prepared dielectric paste and internal electrode paste were used to form a green chip having the two-series structure shown in FIG. 1A by a sheet forming method. Thereafter, the green chip was subject to a binder removal treatment, a firing treatment, and an annealing treatment. As a result, an element body 10 having a rectangular parallelepiped shape with dimensions of 3.2 mm×2.5 mm×2.5 mm was obtained. These dimensions indicate that the element body 10 having the structure shown in FIG. 1A had a length of 3.2 mm along the X-axis, a height of 2.5 mm along the Z-axis (laminated direction), and a width of 2.5 mm along the Y-axis.

In the firing treatment, the holding temperature was set to 1200 to 1300° C., the holding time was set to 2.0 hours, and the firing atmosphere was a reducing atmosphere with an oxygen partial pressure of 2.0×10⁻¹³ atm or higher and 1.0×10⁻⁷ atm or lower. In the obtained element body 10, the number and the average thickness of laminated internal dielectric layers 2 each interposed between the internal electrode layers 3a and 3b were 280 and 6.0 μm, respectively, and the average thickness of the internal electrode layers 3a and 3b was 1.0 μm. The width X1 of the M-gap and the width X2 of the W-gap shown in FIG. 1A were each set to 0.2 mm.

Regarding the holding temperature during firing, preliminary tests were conducted on each sample at six holding temperatures: 1200° C., 1220° C., 1240° C., 1260° C., 1280° C., and 1300° C. Among the holding temperatures at which the element body 10 was densified, the lowest holding temperature was adopted. Whether the element body 10 was densified was determined by observing a cross section of the element body 10 using SEM. Specifically, it was determined whether, in a field of view of at least 450 μm² in a cross section of the element body 10, an area of void regions was 2% or less relative to an area occupied by the dielectric layers within the field of view. When the element body 10 was not densified at any of the holding temperatures, the holding temperature at which the element body 10 exhibited the highest degree of densification was adopted. Accordingly, the holding temperature was set to 1300° C.

Next, a baked electrode layer containing Cu, a Ni plating layer, and a Sn plating layer were formed in this order on the outer surfaces of the element body 10, thereby forming external electrodes 4. As a result, the multilayer ceramic capacitor 1 was obtained.

### (Composition of Dielectric Ceramic Composition)

The composition of the dielectric ceramic composition was analyzed by ICP optical emission spectroscopy using samples obtained from the dielectric layer. It was confirmed that the prepared composition was substantially the same as the dielectric ceramic composition with respect to the contents of A-site elements, B-site elements, and elements contained in Z1 and Z2.

### (Average Grain Size of Main Phase Grains 14)

The average grain size of the main phase grains 14 was measured by observing a cross section of the dielectric layer using SEM. Specifically, an observation range containing at least 50 entire main phase grains 14 was set. The equivalent circular diameters of the main phase grains 14 were calculated and averaged. The equivalent circular diameter of the main phase grain 14 refers to the diameter of a circle having an area equal to that of the main phase grain 14. Results are shown in Table 1.

### (Withstand Voltage Characteristics)

A DC voltage was applied to at least five capacitor samples at an increasing rate of 10 V/s, and the voltage at which a leakage current reached 10 mA was measured. The measured voltage was divided by an inter-electrode dielectric thickness. The average of these values was defined as a breakdown voltage (withstand voltage). A withstand voltage of 70 V/μm or more was evaluated as good, and a withstand voltage of 100 V/μm or more was evaluated as excellent. Results are shown in Table 1.

### (Occurrence Rate of Deflection-Induced Cracking)

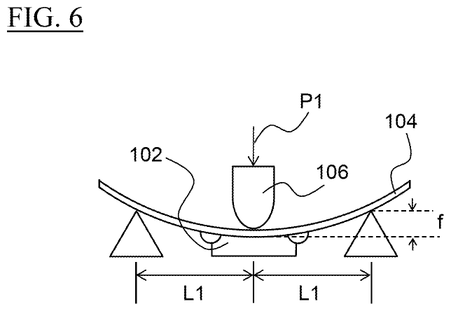

The capacitance of each of 100 capacitor samples was measured using a digital LCR meter at 25° C. under conditions of 1 kHz and 1 Vrms. Next, as shown in FIG. 6, a prepared capacitor sample 102 (the multilayer ceramic capacitor 1 as shown in FIG. 1A) was mounted on a glass epoxy board 104 having a thickness of 1.6 mm using solder (Sn-96.5% Ag-3% Cu-0.5%). The length L1 shown in FIG. 6 was 45 mm. Mounting was performed so that the internal electrode layers 3a and 3b shown in FIG. 1A were parallel to the board 104 shown in FIG. 6.

Thereafter, using a deflection tester, deflection stress was applied to the glass epoxy board 104 in the direction of arrow P1 by means of a pressing jig 106 having a width of 20 mm and a curvature radius of R230. The deflection stress was applied until a deflection amount f reached 10 mm.

The capacitance of each of 100 capacitor samples was measured using a digital LCR meter at 25° C. under conditions of 1 kHz and 1 Vrms. The number of capacitor samples exhibiting a decrease in capacitance or emitting abnormal noise was counted. The results were rated as good when the number of samples was 9 or less, rated as excellent when it was 3 or less, and rated as most excellent when it was zero. Results are shown in Table 1.

### Experimental Example 1: Sample Nos. 2 to 4

The capacitor sample of Sample No. 2 was prepared in the same manner as Sample No. 1, except for the following modifications. The printing pattern of the internal electrode layers was changed so as to form a three-series structure as shown in FIG. 1B. Specifically, the number of M-gaps 2b in the X-axis direction was two, and the number of capacitance units in the element body (the number of laminated units in which the internal electrode layers 3a and 3b overlap when viewed in the Z-axis direction) was three. In addition, the content of W in terms of parts by mol was changed to the value shown in Table 1. The capacitor samples of Sample Nos. 3 and 4 were prepared in the same manner as Sample No. 2, except for the following modifications. The printing pattern of the internal electrode layers was changed so as to form a four-series structure or a five-series structure, although these structures are not shown in the drawings. Specifically, when the number of M-gaps 2b was three, the number of capacitance units in the element body was four, and when the number of M-gaps 2b was four, the number of capacitance units in the element body was five.

The obtained capacitor samples were evaluated in the same manner as Sample No. 1. Results are shown in Table 1.

### Experimental Example 1: Sample No. 5

The capacitor sample of Sample No. 5 was prepared in the same manner as Sample No. 1, except that W was not added as a first subcomponent element. The obtained capacitor sample was evaluated in the same manner as Sample No. 1. Results are shown in Table 1.

### Experimental Example 1: Sample No. 6

The capacitor sample of Sample No. 6 was prepared in the same manner as Sample No. 5, except that the composition of the dielectric ceramic composition was changed and the printing pattern of the internal electrode layers was changed so that the internal electrode layers did not include a floating electrode. The obtained capacitor samples were evaluated in the same manner as Sample No. 1. Results are shown in Table 1.

The capacitor sample of Sample No. 6 did not include a floating electrode 30 shown in FIGS. 1A and 1B. In this sample, one internal electrode layer of a pair of internal electrode layers facing each other in the laminated direction was connected to one of the external electrodes 4, and the other internal electrode layer was connected to the other external electrode 4.

### Experimental Example 1: Sample No. 7

The capacitor sample of Sample No. 7 was prepared in the same manner as that of Sample No. 2, except that the printing pattern of the internal electrode layers was changed so that the internal electrode layers did not include a floating electrode. The obtained capacitor sample was evaluated in the same manner as Sample No. 1. Results are shown in Table 1.

TABLE 1

| | | | | | | | | | | | Occur- |
|---|---|---|---|---|---|---|---|---|---|---|---|
| | | | | | | | | | Mount- | | rence |
| | | | | | Number | | First | | ing | With- | Rate of |
| Example/ | | | Main | Second | of | First | Subcom- | | Direc- | stand | Deflec- |
| Compar- | | | Element | Subcom- | Capaci- | Subcom- | ponent | Grain | tion | Volt- | tion- |
| ative | Sample | | of Elec- | ponent | tance | ponent | [parts | Size | of Elec- | age | induced |
| Example | No. | Dielectric Composition | trode | Element | Units | Element | by mol] | [μm] | trodes | [V/um] | Cracking |
| Example | 1 | (Ca_{0.7}Sr_{0.3})(Zr_{0.96}Ti_{0.03}Hf_{0.01})O₃ | Ni | Mn, Al, Si | 2 | W | 0.25 | 0.90 | Parallel | 139 | 0/100 |
| | | | | | | | | | to Board | | |
| Example | 2 | (Ca_{0.7}Sr_{0.3})(Zr_{0.96}Ti_{0.03}Hf_{0.01})O₃ | Ni | Mn, Al, Si | 3 | W | 0.21 | 1.08 | Parallel | 142 | 0/100 |
| | | | | | | | | | to Board | | |
| Example | 3 | (Ca_{0.7}Sr_{0.3})(Zr_{0.96}Ti_{0.03}Hf_{0.01})O₃ | Ni | Mn, Al, Si | 4 | W | 0.22 | 1.03 | Parallel | 148 | 0/100 |
| | | | | | | | | | to Board | | |
| Example | 4 | (Ca_{0.7}Sr_{0.3})(Zr_{0.96}Ti_{0.03}Hf_{0.01})O₃ | Ni | Mn, Al, Si | 5 | W | 0.22 | 0.95 | Parallel | 151 | 0/100 |
| | | | | | | | | | to Board | | |
| Compar- | 5 | (Ca_{0.7}Sr_{0.3})(Zr_{0.96}Ti_{0.03}Hf_{0.01})O₃ | Ni | Mn, Al, Si | 2 | Not | 0.00 | 1.04 | Parallel | 129 | 18/100 |
| ative | | | | | | added | | | to Board | | |
| Example | | | | | | | | | | | |
| Compar- | 6 | (Ca_{0.7}Sr_{0.3})(Zr_{0.75}Ti_{0.25})O₃ | Ni | Mn, Al, Si | 1 | Not | 0.00 | 0.94 | Parallel | 42 | 0/100 |
| ative | | | | | | added | | | to Board | | |
| Example | | | | | | | | | | | |
| Compar- | 7 | (Ca_{0.7}Sr_{0.3})(Zr_{0.96}Ti_{0.03}Hf_{0.01})O₃ | Ni | Mn, Al, Si | 1 | W | 0.29 | 0.93 | Parallel | 31 | 0/100 |
| ative | | | | | | | | | to Board | | |
| Example | | | | | | | | | | | |

As shown in Table 1, Sample Nos. 1 to 4 exhibited good withstand voltage characteristics and showed suppressed deflection-induced cracking. In these samples, the dielectric layers serving as insulating layers contained a main component and a first subcomponent element at a predetermined ratio, the main component being composed of a perovskite-type compound having a predetermined composition, and the internal electrode layers included the floating electrode 30.

In contrast, withstand voltage was insufficient in Sample Nos. 6 and 7 having a structure in which the internal electrode layers did not include a floating electrode. In addition, resistance to deflection-induced cracking was insufficient in Sample No. 5. In this sample, although the internal electrode layers included the floating electrode as shown in FIG. 1A, the insulating layers did not contain the first subcomponent element Z1.

### Experimental Example 2

The capacitor samples of Sample Nos. 8 to 10 and 13 were prepared in the same manner as Sample No. 1, except that the main component composition of the internal dielectric layer 2 and the external dielectric layer 2a was changed to the value shown in Table 2. The capacitor sample of Sample No. 11 was prepared in the same manner as Sample No. 1, except that Cr₂O₃ powder was added in an amount of 0.5 parts by mol per 1 part by mol of MnCO₃, instead of MnCO₃ powder. The capacitor sample of Sample No. 12 was prepared in the same manner as Sample No. 1, except for the following modifications. In addition to Mn, Al, and Si as the second subcomponent elements, Mg was added as a third subcomponent element Z3. The total content of the second and third subcomponent elements Z2 and Z3 was set to 7.0 parts by mol or less with respect to 100 parts by mol of B-site elements. The obtained capacitor sample was evaluated in the same manner as Sample No. 1. Results are shown in Table 2.

TABLE 2

| | | | | Second | | | | | | | |
|---|---|---|---|---|---|---|---|---|---|---|---|
| | | | | Subcom- | | | | | | | Occur- |
| | | | | ponent | | | | | Mount- | | rence |
| | | | | Element | Number | | First | | ing | With- | Rate of |
| Example/ | | | Main | Third | of | First | Subcom- | | Direc- | stand | Deflec- |
| Compar- | Sam- | | Element | Subcom- | Capaci- | Subcom- | ponent | Grain | tion | Volt- | tion- |
| ative | ple | | of Elec- | ponent | tance | ponent | [parts | Size | of Elec- | age | induced |
| Example | No. | Dielectric Composition | trode | Element | Units | Element | by mol] | [μm] | trodes | [V/um] | Cracking |
| Example | 1 | (Ca_{0.7}Sr_{0.3})(Zr_{0.96}Ti_{0.03}Hf_{0.01})O₃ | Ni | Mn, Al, Si | 2 | W | 0.25 | 0.90 | Parallel | 139 | 0/100 |
| | | | | | | | | | to Board | | |
| Example | 8 | (Ca_{0.7}Sr_{0.3})(Zr_{0.91}Ti_{0.09})O₃ | Ni | Mn, Al, Si | 2 | W | 0.24 | 1.01 | Parallel | 136 | 0/100 |
| | | | | | | | | | to Board | | |
| Example | 9 | (Ca_{0.10}Sr_{0.65}Ba_{0.25})(Zr_{0.94}Ti_{0.06})O₃ | Ni | Mn, Al, Si | 2 | W | 0.27 | 0.99 | Parallel | 131 | 0/100 |
| | | | | | | | | | to Board | | |
| Example | 10 | CaZrO₃ | Ni | Mn, Al, Si | 2 | W | 0.21 | 0.97 | Parallel | 123 | 0/100 |
| | | | | | | | | | to Board | | |
| Example | 11 | (Ca_{0.7}Sr_{0.3})(Zr_{0.96}Ti_{0.03}Hf_{0.01})O₃ | Ni | Cr, Al, Si | 2 | W | 0.21 | 1.01 | Parallel | 127 | 0/100 |
| | | | | | | | | | to Board | | |
| Example | 12 | (Ca_{0.7}Sr_{0.3})(Zr_{0.96}Ti_{0.03}Hf_{0.01})O₃ | Ni | Mn, Mg, | 2 | W | 0.22 | 1.06 | Parallel | 129 | 0/100 |
| | | | | Al, Si | | | | | to Board | | |
| Compar- | 13 | BaTiO₃ | Ni | Mn, Al, Si | 2 | W | 0.28 | 1.09 | Parallel | 35 | 82/100 |
| ative | | | | | | | | | to Board | | |
| Example | | | | | | | | | | | |

As shown in Table 2, even when the composition of the main component or the second subcomponent element was varied, samples satisfying the predetermined configuration exhibited improved withstand voltage and suppressed deflection-induced cracking. On the other hand, Sample No. 13, in which the dielectric layers (insulating layers) were composed of barium titanate, exhibited insufficient withstand voltage and resistance to deflection-induced cracking.

### Experimental Example 3

The capacitor samples of Sample Nos. 14 to 21 were prepared in the same manner as Sample No. 1, except that the first subcomponent element was changed from W to the elements shown in Table 3. These samples were evaluated in the same manner as Sample No. 1. Results are shown in Table 3.

TABLE 3

| | | | | | | | | | | | Occur- |
|---|---|---|---|---|---|---|---|---|---|---|---|
| | | | | | | | | | Mount- | | rence |
| | | | | | Number | | First | | ing | With- | Rate of |
| Example/ | | | Main | Second | of | First | Subcom- | | Direc- | stand | Deflec- |
| Compar- | | | Element | Subcom- | Capaci- | Subcom- | ponent | Grain | tion | Volt- | tion- |
| ative | Sample | | of Elec- | ponent | tance | ponent | [parts | Size | of Elec- | age | induced |
| Example | No. | Dielectric Composition | trode | Element | Units | Element | by mol] | [μm] | trodes | [V/um] | Cracking |
| Example | 1 | (Ca_{0.7}Sr_{0.3})(Zr_{0.96}Ti_{0.03}Hf_{0.01})O₃ | Ni | Mn, Al, Si | 2 | W | 0.25 | 0.90 | Parallel | 139 | 0/100 |
| | | | | | | | | | to Board | | |
| Example | 14 | (Ca_{0.7}Sr_{0.3})(Zr_{0.96}Ti_{0.03}Hf_{0.01})O₃ | Ni | Mn, Al, Si | 2 | W, Nb | 0.23 | 0.96 | Parallel | 131 | 0/100 |
| | | | | | | | | | to Board | | |
| Example | 15 | (Ca_{0.7}Sr_{0.3})(Zr_{0.96}Ti_{0.03}Hf_{0.01})O₃ | Ni | Mn, Al, Si | 2 | W, Ta | 0.25 | 1.01 | Parallel | 125 | 0/100 |
| | | | | | | | | | to Board | | |
| Example | 16 | (Ca_{0.7}Sr_{0.3})(Zr_{0.96}Ti_{0.03}Hf_{0.01})O₃ | Ni | Mn, Al, Si | 2 | Nb | 0.25 | 1.02 | Parallel | 118 | 0/100 |
| | | | | | | | | | to Board | | |
| Example | 17 | (Ca_{0.7}Sr_{0.3})(Zr_{0.96}Ti_{0.03}Hf_{0.01})O₃ | Ni | Mn, Al, Si | 2 | Ta | 0.21 | 0.94 | Parallel | 115 | 0/100 |
| | | | | | | | | | to Board | | |
| Example | 18 | (Ca_{0.7}Sr_{0.3})(Zr_{0.96}Ti_{0.03}Hf_{0.01})O₃ | Ni | Mn, Al, Si | 2 | V | 0.28 | 1.05 | Parallel | 109 | 0/100 |
| | | | | | | | | | to Board | | |
| Compar- | 19 | (Ca_{0.7}Sr_{0.3})(Zr_{0.96}Ti_{0.03}Hf_{0.01})O₃ | Ni | Mn, Al, Si | 2 | Mo | 0.30 | 1.10 | Parallel | 98 | 14/100 |
| ative | | | | | | | | | to Board | | |
| Example | | | | | | | | | | | |
| Compar- | 20 | (Ca_{0.7}Sr_{0.3})(Zr_{0.96}Ti_{0.03}Hf_{0.01})O₃ | Ni | Mn, Al, Si | 2 | Y | 0.22 | 1.10 | Parallel | 120 | 10/100 |
| ative | | | | | | | | | to Board | | |
| Example | | | | | | | | | | | |
| Compar- | 21 | (Ca_{0.7}Sr_{0.3})(Zr_{0.96}Ti_{0.03}Hf_{0.01})O₃ | Ni | Mn, Al, Si | 2 | Dy | 0.29 | 1.07 | Parallel | 124 | 11/100 |
| ative | | | | | | | | | to Board | | |
| Example | | | | | | | | | | | |

As shown in Table 3, each example including at least one selected from the group consisting of V, Nb, Ta, and W was included as the first subcomponent element and satisfying the predetermined configuration exhibited improved withstand voltage and suppressed deflection-induced cracking. These examples showed such improvements compared with the comparative examples that did not include the first subcomponent element.

### Experimental Example 4

The capacitor samples of Sample Nos. 22 to 26 were prepared in the same manner as Sample No. 1, except that the amount of W was changed to the value shown in Table 4. These samples were evaluated in the same manner as Sample No. 1. Results are shown in Table 4.

TABLE 4

| | | | | | | | | | | | Occur- |
|---|---|---|---|---|---|---|---|---|---|---|---|
| | | | | | | | | | Mount- | | rence |
| | | | | | Number | | First | | ing | With- | Rate of |
| Example/ | | | Main | Second | of | First | Subcom- | | Direc- | stand | Deflec- |
| Compar- | | | Element | Subcom- | Capaci- | Subcom- | ponent | Grain | tion | Volt- | tion- |
| ative | Sample | | of Elec- | ponent | tance | ponent | [parts | Size | of Elec- | age | induced |
| Example | No. | Dielectric Composition | trode | Element | Units | Element | by mol] | [μm] | trodes | [V/um] | Cracking |
| Example | 22 | (Ca_{0.7}Sr_{0.3})(Zr_{0.96}Ti_{0.03}Hf_{0.01})O₃ | Ni | Mn, Al, Si | 2 | W | 0.005 | 1.06 | Parallel | 76 | 3/100 |
| | | | | | | | | | to Board | | |
| Example | 23 | (Ca_{0.7}Sr_{0.3})(Zr_{0.96}Ti_{0.03}Hf_{0.01})O₃ | Ni | Mn, Al, Si | 2 | W | 0.01 | 0.98 | Parallel | 135 | 0/100 |
| | | | | | | | | | to Board | | |
| Example | 24 | (Ca_{0.7}Sr_{0.3})(Zr_{0.96}Ti_{0.03}Hf_{0.01})O₃ | Ni | Mn, Al, Si | 2 | W | 0.03 | 1.00 | Parallel | 139 | 0/100 |
| | | | | | | | | | to Board | | |
| Example | 1 | (Ca_{0.7}Sr_{0.3})(Zr_{0.96}Ti_{0.03}Hf_{0.01})O₃ | Ni | Mn, Al, Si | 2 | W | 0.25 | 0.90 | Parallel | 139 | 0/100 |
| | | | | | | | | | to Board | | |
| Example | 25 | (Ca_{0.7}Sr_{0.3})(Zr_{0.96}Ti_{0.03}Hf_{0.01})O₃ | Ni | Mn, Al, Si | 2 | W | 0.75 | 0.91 | Parallel | 137 | 0/100 |
| | | | | | | | | | to Board | | |
| Example | 26 | (Ca_{0.7}Sr_{0.3})(Zr_{0.96}Ti_{0.03}Hf_{0.01})O₃ | Ni | Mn, Al, Si | 2 | W | 0.80 | 0.96 | Parallel | 90 | 1/100 |
| | | | | | | | | | to Board | | |

As shown in Table 4, even when the amount of the first subcomponent element was varied, samples satisfying the predetermined configuration exhibited improved withstand voltage and suppressed deflection-induced cracking. When the amount of the first subcomponent element was 0.005 parts by mol or more and 0.80 parts by mol or less, withstand voltage was improved and deflection-induced cracking was suppressed. Preferably, the amount was 0.01 parts by mol or more and 0.75 parts by mol or less.

### Experimental Example 5

The capacitor samples of Sample Nos. 27 to 30 were prepared in the same manner as Sample No. 1, except that the particle size of the main component raw material powder was changed by varying the grinding time to adjust the grain size of the main phase grains. These samples were evaluated in the same manner as Sample No. 1. Results are shown in Table 5.

TABLE 5

| | | | | | | | | | | | Occur- |
|---|---|---|---|---|---|---|---|---|---|---|---|
| | | | | | | | | | Mount- | | rence |
| | | | | | Number | | First | | ing | With- | Rate of |
| Example/ | | | Main | Second | of | First | Subcom- | | Direc- | stand | Deflec- |
| Compar- | | | Element | Subcom- | Capaci- | Subcom- | ponent | Grain | tion | Volt- | tion- |
| ative | Sample | | of Elec- | ponent | tance | ponent | [parts | Size | of Elec- | age | induced |
| Example | No. | Dielectric Composition | trode | Element | Units | Element | by mol] | [μm] | trodes | [V/um] | Cracking |
| Example | 27 | (Ca_{0.7}Sr_{0.3})(Zr_{0.96}Ti_{0.03}Hf_{0.01})O₃ | Ni | Mn, Al, Si | 2 | W | 0.29 | 0.08 | Parallel | 72 | 3/100 |
| | | | | | | | | | to Board | | |
| Example | 28 | (Ca_{0.7}Sr_{0.3})(Zr_{0.96}Ti_{0.03}Hf_{0.01})O₃ | Ni | Mn, Al, Si | 2 | W | 0.28 | 0.11 | Parallel | 125 | 0/100 |
| | | | | | | | | | to Board | | |
| Example | 1 | (Ca_{0.7}Sr_{0.3})(Zr_{0.96}Ti_{0.03}Hf_{0.01})O₃ | Ni | Mn, Al Si | 2 | W | 0.25 | 0.90 | Parallel | 139 | 0/100 |
| | | | | | | | | | to Board | | |
| Example | 29 | (Ca_{0.7}Sr_{0.3})(Zr_{0.96}Ti_{0.03}Hf_{0.01})O₃ | Ni | Mn, Al, Si | 2 | W | 0.23 | 2.95 | Parallel | 123 | 0/100 |
| | | | | | | | | | to Board | | |
| Example | 30 | (Ca_{0.7}Sr_{0.3})(Zr_{0.96}Ti_{0.03}Hf_{0.01})O₃ | Ni | Mn, Al, Si | 2 | W | 0.25 | 3.51 | Parallel | 75 | 2/100 |
| | | | | | | | | | to Board | | |

As shown in Table 5, even when the grain size of the main phase grains was varied, samples satisfying the predetermined configuration exhibited improved withstand voltage and suppressed deflection-induced cracking. In addition, withstand voltage was improved, and deflection-induced cracking was suppressed, when the grain size of the main phase grains was preferably 0.08 μm or more and 3.51 μm or less, more preferably 0.11 μm or more and 2.95 μm or less.

### Experimental Example 6

The capacitor sample of Sample No. 31 was prepared in the same manner as Sample No. 1. The sample was evaluated in the same manner as Sample No. 1, except that the mounting direction was changed so that the internal electrode layers were oriented substantially perpendicular to the glass epoxy board 104 shown in FIG. 6. Results are shown in Table 6.

TABLE 6

| | | | | | | | | | | | Occur- |
|---|---|---|---|---|---|---|---|---|---|---|---|
| | | | | | | | | | Mount- | | rence |
| | | | | | Number | | First | | ing | With- | Rate of |
| Example/ | | | Main | Second | of | First | Subcom- | | Direc- | stand | Deflec- |
| Compar- | | | Element | Subcom- | Capaci- | Subcom- | ponent | Grain | tion | Volt- | tion- |
| ative | Sample | | of Elec- | ponent | tance | ponent | [parts | Size | of Elec- | age | induced |
| Example | No. | Dielectric Composition | trode | Element | Units | Element | by mol] | [μm] | trodes | [V/um] | Cracking |
| Example | 31 | (Ca_{0.7}Sr_{0.3})(Zr_{0.96}Ti_{0.03}Hf_{0.01})O₃ | Ni | Mn, Al, Si | 2 | W | 0.25 | 1.06 | Perpen- | 130 | 0/100 |
| | | | | | | | | | dicular | | |
| | | | | | | | | | to Board | | |
| Example | 1 | (Ca_{0.7}Sr_{0.3})(Zr_{0.96}Ti_{0.03}Hf_{0.01})O₃ | Ni | Mn, Al, Si | 2 | W | 0.25 | 0.90 | Parallel | 139 | 0/100 |
| | | | | | | | | | to Board | | |

As shown in Table 6, in the capacitor sample of the example satisfying the predetermined configuration, withstand voltage characteristics were improved, and deflection-induced cracking was effectively suppressed, regardless of the mounting direction.

### REFERENCE SIGNS LIST

1, 1a . . . multilayer ceramic capacitor (multilayer ceramic electronic device)
2 . . . internal dielectric layer (insulating layer)
2a . . . external dielectric layer (insulating layer)
2b . . . M-gap
2c . . . W-gap
3a . . . first internal electrode layer
3a1, 3a2 . . . divided electrode layer
3b . . . second internal electrode layer
3b1, 3a2 . . . divided electrode layer
30 . . . floating electrode
4 . . . external electrode
10 . . . element body
10a . . . end face
14 . . . main phase grain

What is claimed is:

1. A multilayer ceramic electronic device comprising:
an element body having a laminated structure including an insulating layer interposed between a first internal electrode layer and a second internal electrode layer; and
two external electrodes formed on outer surfaces of the element body,
wherein at least one of the first internal electrode layer and the second internal electrode layer includes a floating electrode that is not connected to either of the two external electrodes,
the insulating layer includes a main component including a perovskite-type compound and also includes a subcomponent,
the perovskite-type compound includes at least Ca as an A-site element and at least Zr as a B-site element,
the subcomponent includes at least one selected from the group consisting of V, Nb, Ta, and W as a first subcomponent element, and
a total content of the first subcomponent element is 0.005 parts by mol or more and 0.80 parts by mol or less per 100 parts by mol of B-site elements.

2. The multilayer ceramic electronic device according to claim 1, wherein the total content of the first subcomponent element is 0.01 parts by mol or more and 0.75 parts by mol or less per 100 parts by mol of B-site elements.

3. The multilayer ceramic electronic device according to claim 1, wherein the insulating layer includes main phase grains composed mainly of the main component and also includes grain boundaries present between the main phase grains.

4. The multilayer ceramic electronic device according to claim 3, wherein an average grain size of the main phase grains is 0.08 to 3.51 μm.

5. The multilayer ceramic electronic device according to claim 3, wherein the first subcomponent element is present in a larger amount in the grain boundaries than in the main phase grains.

6. The multilayer ceramic electronic device according to claim 1, wherein the perovskite-type compound further contains at least Sr as the A-site element and contains at least Ti as the B-site element.

7. The multilayer ceramic electronic device according to claim 1, wherein the perovskite-type compound is represented by the following formula: 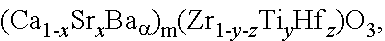
in which the following conditions are satisfied: 0.9≤m≤1.1, 0≤x≤1, 0.80≤1−y−z≤1.0, and α<1.
